(19) United States
(12) Patent Application Publication
(10) Pub. No.: US 2002/0059422 A1
(43) Pub. Date: May 16, 2002

(54) Method and apparatus for providing an information transaction machine (ITM) or the like for public access to the internet which allows advertiser accountability on multiple users through a single ITM

(76) Inventor: John Hutzenlaub, Oak Park, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/932,744

(22) Filed: Aug. 17, 2001

Related U.S. Application Data
(60) Provisional application No. 60/229,885, filed on Sep. 1, 2000.

(51) Int. Cl. G06F 15/173

(52) U.S. Cl. 709/225

(57) ABSTRACT

An information transaction machine or the like for public access to the Internet by an end user enables the end user to gain free access starting either with a data chip having a unique code or an input means with later dispensing of a data chip for future use. Free access is provided to the end user in exchange for demographic data attributed to the user and such data is in turn provided to advertisers during use for allowing such advertisers to stream targeted advertisements or messages at the user.

### CROSS-REFERENCE TO RELATED PATENT APPLICATIONS

This patent application claims the benefit of U.S. Provisional Patent Application No. 60/229,885, filed Sep. 1, 2000.

### FIELD OF THE INVENTION

The present invention relates generally to Information Transaction Machines (ITM's) (e-kiosks) or the like for public access to the internet and particularly to an improved (ITM) (e-kiosk) which allows advertisers accountability on multiple users through a single (ITM) (e-kiosk).

### BACKGROUND OF THE INVENTION

The Information Transaction Machine (ITM) (e-kiosk) for public access to the internet is a relatively new product. An Information Transaction Machine (ITM) (e-kiosk) is defined as a networked inter-operational information machine that contains the technology to provide goods, and personal or business information using voice, data, video and multimedia communications. It's primary user interface is a touch screen display and secondary keyboard/mouse multilingual monitor display that allows end users to navigate a pre-developed presentation by touching prompts on the screen.

Components of an Information Transaction Machine (ITM) (e-kiosk) include the enclosure, software, hardware, touch screen, and other peripheral devices such as a keyboard, mouse, printer, scanner, credit card reader, telephone handset, e-mail carrier, high-speed laptop access point, and other additional video display screens and secondary monitors may also be incorporated.

The Information Transaction Machine (ITM) (e-kiosk) is part of today's corporate advertising strategy because it provides a new method for streaming video and rich multimedia content delivered with superior efficiency and quality to public locations while providing activity data collection.

Consumers are given free internet access for entering limited demographic data each time they use the (ITM) (e-kiosk) affording activity feedback by user profile. Because of the limited user profile data collected, advertising rates have been based on passive traffic counts/per location resulting in low revenues, based on Cost Per Thousand (CPM) revenue rates of $1.00-$2.00/per 1,000 traffic count.

The invention provides such a composition. These and other advantages of the invention, as well as additional inventive features, will be apparent from the description of the invention provided herein.

### BRIEF SUMMARY OF THE INVENTION

Accordingly it is a primary objective of the invention to provide an Information Transaction Machine (ITM) (e-kiosk) construction which will drive higher (CPM) revenue rates (i.e., $80.00-$120.00/1,000) not available in previous constructions, by incorporating a personalization enabler/identifier.

It is also an object of the invention to not only provide this improvement to new Information Transaction Machines (ITM's) (e-kiosks) but for it to be easily retrofitted into existing Information Transaction Machines (ITM's) (e-kiosks) already deployed in the field.

It is yet another object of the invention to allow any consumer to be identified across different Information Transaction Machines (ITM's) (e-kiosks) networks.

In accordance with these and other objects of the invention, there is incorporated in each Information Transaction Machine (ITM) (e-kiosk) one or more mechanical dispensers of bit stream oscillators/data chips (personalization enabler/identifiers) appropriately configured to be hung on a key chain and the appropriate number of bit stream oscillator/data chip readers incorporated into the user interface log on devices by which the first time an end user uses a Information Transaction Machine (ITM) (e-kiosk) a bit stream oscillator/data chip will be dispensed to the end user and upon completion of entering their “expanded” demographic data will place the bit stream oscillator/data chip in contact with the appropriate reader, thus activating their access and simultaneously identifying the end user electronically with the bit steam oscillators/data chips unique code.

According to the preferred embodiment of the invention, the end user can then use the bit stream oscillator/data chip for immediate access without signing on at any Information Transaction Machine (ITM) (e-kiosks) location.

The bit stream oscillator/data chip code associated with the end user will then allow the paid advertiser to specifically stream targeted advertising at this specific end user in a public environment resulting in making a self service multi-user Information Transaction Machine (ITM) (e-kiosk) in a public location act as if it were a personal computer at the end users residence or place of business. (home/business computers are identified by recognizing an advertisers imbedded code (a “cookie”).

The use of bit stream oscillators/data chips and readers of the present invention can be further utilized as the physical access control system for the enclosure identifying authorized service attendants dates and times of entrance and exit.

The invention provides a method and apparatus enabling an end user to gain free access to the internet at an ITM or like device starting either with a data chip having a unique code or an input means with later dispensing of a data chip for future use by the user. The end user is granted free access to the internet in exchange for providing demographic data and such data is provided to advertisers during use for allowing such advertisers to stream targeted advertisements or messages at the user.

### BRIEF DESCRIPTION OF THE DRAWINGS

FIG. 1 is a perspective view of an exemplary ITM/e-kiosk that can incorporate and be used with the present invention;

FIG. 2 is a top plan view of a bit stream oscillator or data chip used with the ITM;

FIG. 3 is a plan view of a bit stream oscillator reader used with the data chip;

FIG. 4 is a process flow chart showing the operational steps of the present invention; and

FIG. 5 is a process flow chart showing the operation with a first time user.

### DETAILED DESCRIPTION OF THE INVENTION

While the invention will be described in reference to the preferred embodiments, it will be obvious to those of ordinary skill in the art that variations of these preferred embodiments may be used and it is intended that the invention may be practiced otherwise than as specifically described within.

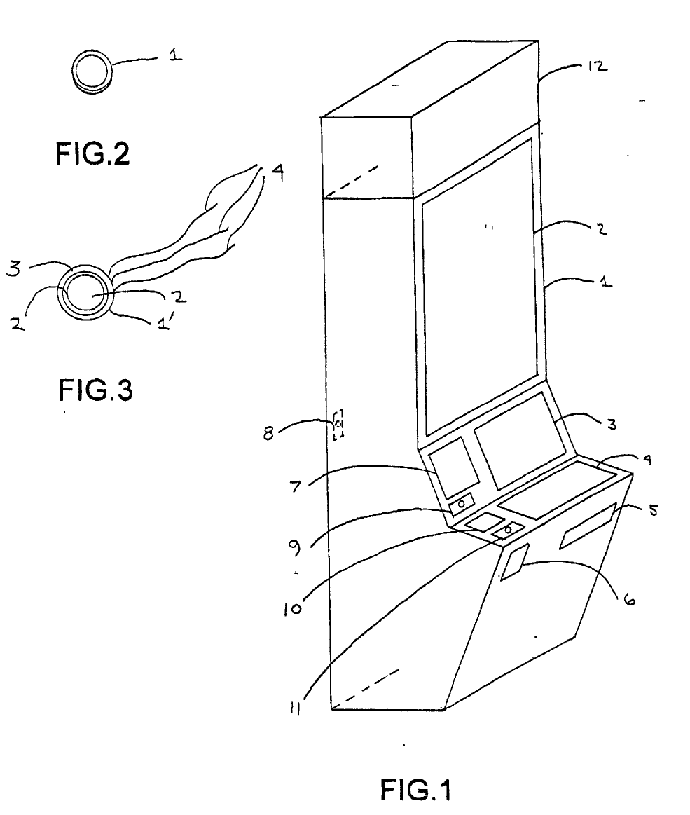

Referring to the drawing FIG. 1, the exemplary ITM enclosure indicated at 1, has a video display screen 2, a secondary monitor or touch screen 3 and an input device 4 such as a keyboard or mouse. The enclosure also has a printer delivery slot 5 and a data chip or bit stream oscillator delivery slot 6.

The kiosk can also be provided with a telephone headset 7.

Other features incorporated into the kiosk are a data chip reader access 8, a reader access control 9 to the phone, a dispensing control 10 and a reader 11 for access control to the free internet. The kiosk further includes a back lit digital message display header 12.

FIGS. 2 and 3 respectively, illustrate an exemplary bit stream oscillator 1 and a reader 1 having a contact 2, mounting flange 3, and 3-wire connection 4. Reference, may be made to the available industry trade literature for details of an i-button and reading devices useful with the present invention. Examples may be found on the internet at www.ibutton.com or www.dalsemi.com.

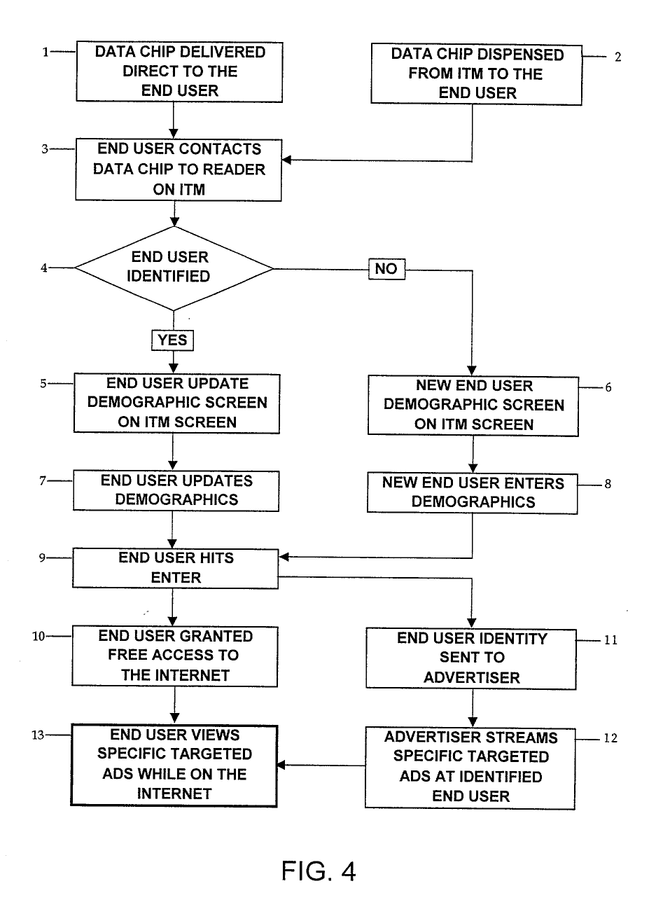

Referring now to the drawing flow charts, FIG. 4 depicts the process in which an End User has either received a data chip prior to arriving at the ITM or will receive a data chip dispensed directly from the ITM. In Cell 1 the End User has been delivered a data chip prior to arriving at the ITM.

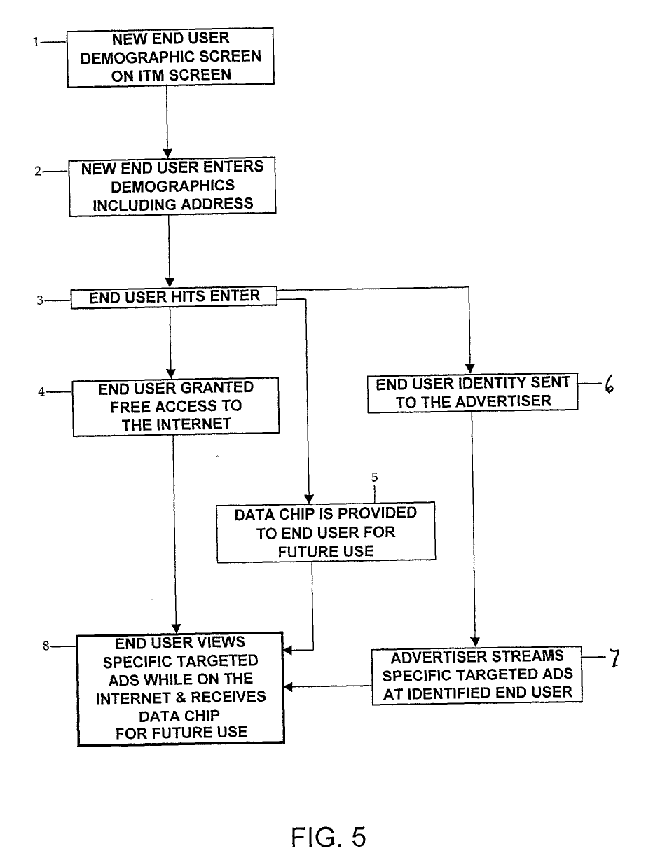

The source of the data chip could be from the process depicted in FIG. 5 (End User identity known and data chip already linked to the End User demographic), hand delivered at the site via a promotion (End User identity not known), mass mailing by a paid advertiser to a known group of accounts by a company to its account base (End User identity known and data chip already linked to the End User demographic), mass delivery via a promotion by a retailer to its walk-in traffic (End User identity not known.)

In Cell 2 the data chip is delivered to the End User via a vending machine type dispensing mechanism (End User identity not known.) In Cell 3 the End User contacts the data chip to the reader on the ITM. In Cell 4 the ITM determines whether the End User is identified by the data chip; if yes, the process Sequences per Cells 5-7-9 and if no, the process Sequences per Cells 6-8-9.

In the Sequence 5-7-9 in which the ITM identifies the End User, in Cell 5 the ITM brings up the End User update screen. In Cell 7 if the demographic data is incorrect on the update screen the End User can edit the information. If the information is correct on the update screen the End User does not edit the information.

In Sequence 6-8-9 in which the ITM could not identify the End User, in Cell 6 the ITM brings up the new End User screen. In Cell 8 the New End User inputs via a keyboard, touch screen, or other input device, the New End User's minimum demographics including name, address, age, and gender. In Cell 9 upon either updating or verifying the demographic information in Cell 7 or inputting the new demographic information in Cell 8, the End User presses Enter initiating two processes.

The two processes are depicted in Cell Sequence 10-13 and in Cell Sequence 11-12-13. In Cell 10 of Cell Sequence 10-13, the End User gains access to the internet and or phone lines. In Cell 11 of Cell Sequence 11-12-13 the demographic information is electronically linked to the data chip code and is reviewed by the Network Operations Center (N.O.C.) and the N.O.C. determines which advertisements from the library of predetermined targeted advertisements based on the End User's demographic model are to be sent to the End User at the ITM location.

In Cell 12 of Cell Sequence 11-12-13 the N.O.C. streams back to the End User at the ITM the predetermined specific advertisements from the library of advertisements targeted at the End User's demographic model. The N.O.C. records the transaction in its database for the purpose of fixture reporting. In Cell 13 of Cell Sequence 10-13 and Cell Sequence 11-12-13 the End User, having gained access to the internet and or phone lines, navigates the internet while the mast head advertisements, banner advertisements, and screen saver advertisements or other message data, appear on the screen that the End User views. The specific targeted advertisements are streamed to the End User from the N.O.C. and the library of the paid for advertisements. All End User responses to the targeted advertisements are recorded and the data is retrieved by the N.O.C. for the purpose of future reporting.

FIG. 5 depicts the process of a New End User's first time use of an ITM. In Cell 1 of the process the New End User, when attempting to use the ITM and not having a data chip in their possession to prompt the ITM, the ITM will automatically bring up the New End User demographic screen on the ITM.

In Cell 2 the New End User inputs via a keyboard, touch screen etcetera, the End User's minimum demographics including name, address, age, and gender. In Cell 3 the End User, upon completion of the entry of their demographic information, the End User presses Enter initiating three processes.

The three processes are depicted in Cell Sequence 4-8, Cell Sequence 5-8, and Cell Sequence 6-7-8. In Cell 4 of Cell Sequence 4-8 the End User is granted access to the internet and or phone lines.

In Cell 5 of Cell Sequence 5-8 the demographic information is received by the Network Operations Center (N.O.C.) and a unique data chip code is electronically linked to the End User's demographics and the data chip is delivered to the End User for future use.

In Cell 6 of Cell Sequence 6-7-8 the demographic information electronically linked to the data chip code is reviewed by the N.O.C. and the N.O.C. determines which advertisements from the library of predetermined targeted advertisements based on the End User's demographic model are to be sent to the End User at the ITM location.

In Cell 7 of the Cell Sequence 6-7-8 the N.O.C. streams back to the End User at the ITM the predetermined specific advertisements from the library of advertisements targeted at the End User's demographic model. The N.O.C. records the transaction in its database for the purpose of future reporting.

In Cell 8 of Cell sequence 4-8, Cell Sequence 5-8, and Cell Sequence 6-7-8 the End User, having gained access to the internet and phone lines, navigates while the mast head advertisements, banner advertisements, and screen saver advertisements or other message data, appear on the screen that the End User views. The specific targeted advertisements are streamed to the End User from the N.O.C. and the library of the paid for advertisements. All End User responses to the targeted advertisements are recorded and the data is retrieved by the N.O.C. for the purpose of future reporting. The End User receives the data chip with the End User unique code via mail or other method of delivery for the End User's future use at any of the locations within the ITM network.

Other Options For Identifying End Users

1. Dispense plastic card with mag strip (more costly dispensing & reading mechanisms)

2. Dispense plastic card with bar code (more costly dispensing & reading mechanisms)

3. Use Biometrics Readers (more costly reading mechanisms)

4. Proximity devices and readers (more costly dispensing & reading mechanisms)

Using Bank Cards

1. Consumers are not comfortable using an existing credit card or bankcard to access a “free” local phone or to gain access to the internet for “free”.

Other Methods of Delivering Data Chips

1. Advertisers can also deliver data chips to targeted end users

2. Malls can deliver data chips to targeted end users

3. Network Operations Centers (NOCs) can also Deliver data chips to targeted end users

Incentive/Loyalty Programs for the above can be linked to the release of data chips to end-users.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. “ITM” is intended to include other machines and devices such as integrated phone systems or like appliances that can access the Internet. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of providing an information transaction machine or the like for public access by an end user to the Internet comprising the steps of:
providing a data chip having a unique code to an end user;
requiring the end user to enter certain demographic data pertaining to the end user;
granting access to the Internet in exchange for the demographic data provided by the end user; and
matching the data provided by the end user with the data chip provided to the end user.

2. A method as claimed in claim 1 wherein the data chip is delivered to the end user prior to accessing the informational transaction machine.

3. A method as claimed in claim 1 wherein the data chip is dispensed to the end user at the informational transactional machine

4. A method as claimed in claim 1 wherein the data chip is dispensed from the information transaction machine at the conclusion of a session for future use.

5. A method as claimed in claims 1 or 2 wherein the end user is required to update data upon accessing the information transaction machine with the provided data chip.

6. A method as claimed in claim 1 wherein the end user demographic data is sent to preselected advertisers during a use session.

7. A method as claimed in claim 6 wherein specific targeted advertisements are streamed at the end user during a use session.

8. In an information transaction machine or the like for public access to the Internet by an end user the combination comprising, a data chip reading means for accessing and using the information transaction machine;
input means for allowing the end user to access the ITM by inputting certain required demographic data; and,
dispensing means for delivery of a data chip to the end user for future use of an information transaction machine.

9. An ITM as claimed in claim 8 wherein the data chip is in the form of an ibutton.
